(19) United States
(12) Patent Application Publication
(10) Pub. No.: US 2012/0182138 A1
(43) Pub. Date: Jul. 19, 2012

(54) VEHICLE PRESENCE NOTIFICATION APPARATUS

(75) Inventors: Toshiaki NAKAYAMA, Miyoshi-city (JP); Koji Suzuki, Kosai-city (JP); Yoshiaki Watanabe, Kosai-city (JP)

(73) Assignees: HAMANAKODENSO CO., LTD., Kosai-city (JP); DENSO CORPORATION, Kariya-city (JP)

(21) Appl. No.: 13/352,492

(22) Filed: Jan. 18, 2012

(30) Foreign Application Priority Data
Jan. 18, 2011 (JP) 2011-7802

(51) Int. Cl. B60Q 1/00; B60H 1/00; B62D 25/08

(52) U.S. Cl. 340/425.5; 296/193.1; 165/47

(57) ABSTRACT

A vehicle includes a front grille and a vehicle presence notification apparatus that includes a supersonic speaker, where the vehicle presence notification apparatus is behind the front grille. The front grille includes a plurality of grille bars that may be in a front range of the supersonic speakers. The grille bars that are positioned in the front range of the supersonic speaker includes a curved convex and an upper plate, which have a substantial U shape cross section. The supersonic wave is reflected on an inside surface of one grille bar in a downward direction, and is reflected again on an outside surface of an adjacent grille bar in a forward or frontal direction to output toward a front field of the vehicle.

### CROSS REFERENCE TO RELATED APPLICATION

The present application is based on and claims the benefit of priority of Japanese Patent Application No. 2011-7802, filed on Jan. 18, 2011, the disclosure of which is incorporated herein by reference.

### TECHNICAL FIELD

The present disclosure generally relates to a vehicle presence notification apparatus that generates a notification sound for warning a pedestrian and the like around the vehicle about the approach of the vehicle.

### BACKGROUND

A warning device that outputs a sound to notify others in the vicinity of the traveling vehicle is disclosed in Japanese Patent Laid-Open No. 2005-289175 (JP '175). The vehicle warning apparatus of JP '175 generates a warning sound from a dynamic speaker.

A vehicle warning apparatus may use a different type of speaker that provides a strong directivity to generate a warning sound. In order to effectively emit a warning sound in a particular direction, the speaker of the vehicle warning apparatus may be affixed to a front portion of the vehicle, where the speaker is directed towards a frontal direction of the vehicle. However, such position may not be appropriate for the speaker due to the spatial restrictions and interferences with other components that may alter and effect the projection and quality of the sound wave as it is emitted from the speaker.

### SUMMARY

A vehicle presence notification apparatus may be equipped in a vehicle that includes a front grille to cover a front opening of the vehicle. The vehicle presence notification apparatus may include a parametric speaker that produces a supersonic wave by supersonic modulation of a notification signal. The supersonic wave is then emitted from a supersonic speaker that is arranged with the parametric speaker. The supersonic speaker is positioned under a hood of the vehicle and behind the front grille.

The front grille may include a plurality of grill bars, the supersonic speaker emits the supersonic wave between a space defined by the grill bars. The grille bar includes a curved convex portion that protrudes outward away from the vehicle, an upper and lower plate that extend towards the vehicle from an upper portion and a lower portion of the curved convex portion respectively. A grille bars that is positioned in a front range of the supersonic speaker may only include the curved convex portion and the upper plate portion that extends from an upper end of the curved convex toward the back of the vehicle.

In such manner, the supersonic wave is reflected by an inside surface of a grille bar and is redirected downward, where it is reflected again on an outer surface of an adjacent lower grille bar. The supersonic wave is then directed outward towards a frontal direction of the vehicle.

### BRIEF DESCRIPTION OF THE DRAWING

Objects, features, and advantages of the present disclosure will become more apparent from the following detailed description made with reference to the accompanying drawings, in which:

FIG. 1 is an illustration of a vehicle presence notification apparatus in a front part of a vehicle of the present disclosure;

FIGS. 2A and 2B are illustrations of a supersonic wave reflection by a grille bar of the present disclosure;

FIG. 3A is a cross-sectional view of the vehicle presence notification apparatus of the present disclosure;

FIG. 3B is a perspective view of the vehicle presence notification apparatus of the present disclosure;

FIG. 4 is a diagram of a frequency characteristic of a vehicular horn of the vehicle presence notification apparatus of the present disclosure;

FIGS. 5A and 5B are illustrations of outreach areas of a notification sound of the present disclosure;

FIG. 6 is a block diagram of the vehicle presence notification apparatus of the present disclosure;

FIGS. 7A, 7B, 7C, 7D and 7E are illustrations of an operation principle of a parametric speaker of the vehicle presence notification apparatus of the present disclosure; and

FIG. 8 is an illustration of the vehicle presence notification apparatus in a front part of a vehicle with the supersonic wave reflected from the grill bar of the present disclosure.

### DETAILED DESCRIPTION

Embodiments of the present disclosure are explained with reference to the drawings. In the following examples, like parts have like numbers. It is to be noted that the following examples do not limit the present disclosure only to themselves.

(Configuration Used in the Embodiment)

A vehicle 100 in the present embodiment may generate driving power by using an electric motor and/or an internal combustion engine, such as an electric vehicle, a hybrid vehicle, or the like. As a result the vehicle 100, may be considered a quiet vehicle that generates little to no sound when the vehicle 100 is in operation.

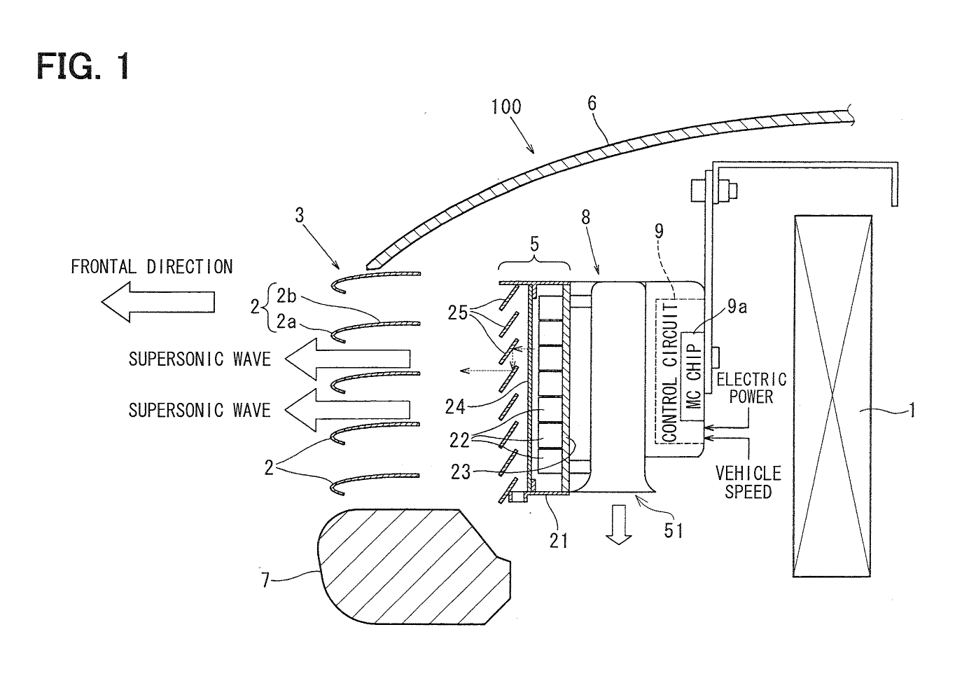

With reference to FIG. 1, the vehicle 100 includes a heat exchanger 1, a front grille 3, an engine hood 6, and a bumper 7. The heat exchanger 1, as known in the art, may be a radiator that transfers heat created during the operation of the vehicle 100 to the air passing through the heat exchanger 1. The heat exchanger may also have a condenser that transfers heat from refrigerant. The present disclosure may be applicable to a vehicle that does not have a radiator, that is, the apparatus may be applicable to an electric vehicle, or the like.

The front grille 3 of the vehicle 100 covers a front opening of the vehicle 100, which is defined by a body of the vehicle 100 (i.e hood, bumper, side panel, and the like), to protect the internal components such as, the heat exchanger 1, an engine, a motor, and the like. The front grille 3 in the present embodiment is molded by resin, and has a plurality of horizontally-extending grille bars 2 (i.e., grille members) for forming the front grille 3.

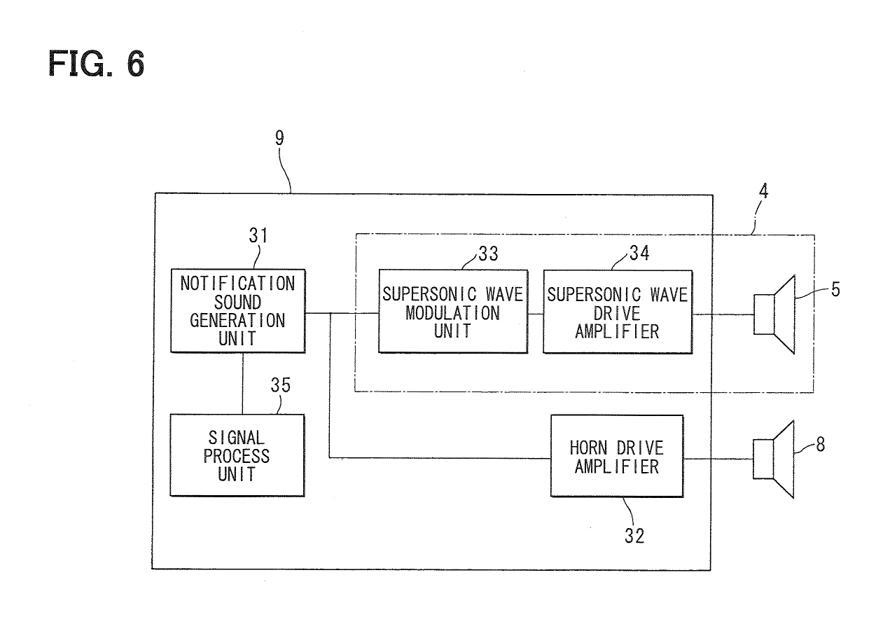

The vehicle 100 includes a vehicle presence notification apparatus to notify the surrounding area of the presence and approach of the vehicle 100. The vehicle presence notification apparatus includes a parametric speaker 4 (FIG. 6) that outputs a supersonic wave via a supersonic speaker 5, a vehicular horn 8 that is operated as a dynamic speaker, and a control circuit 9 that controls the operation of the vehicular horn 8 and the supersonic speaker 5. The notification sound may be produced based on a travel condition of the vehicle 100 or when a pedestrian is detected by a sensor or the like.

The vehicle presence notification apparatus is configured to output the notification sound from both the parametric speaker 4, which uses a supersonic wave, and the vehicular horn 8, which serves as a dynamic speaker, toward the surrounding area of the vehicle 100.

(Vehicular Horn 8)

The vehicle 100 of the present embodiment also includes a vehicular horn 8, which may be an electro-magnetic type horn. The vehicular horn 8 emits a warning sound when a horn switch (e.g., a horn button on a steering wheel) is operated by an occupant of the vehicle 100. That is when the horn switch is engaged, the vehicular horn 8 generates the warning sound when a self-excitation voltage is above a threshold voltage, such as 8 V or more. The vehicular horn 8 is disposed in a front portion of the vehicle 100.

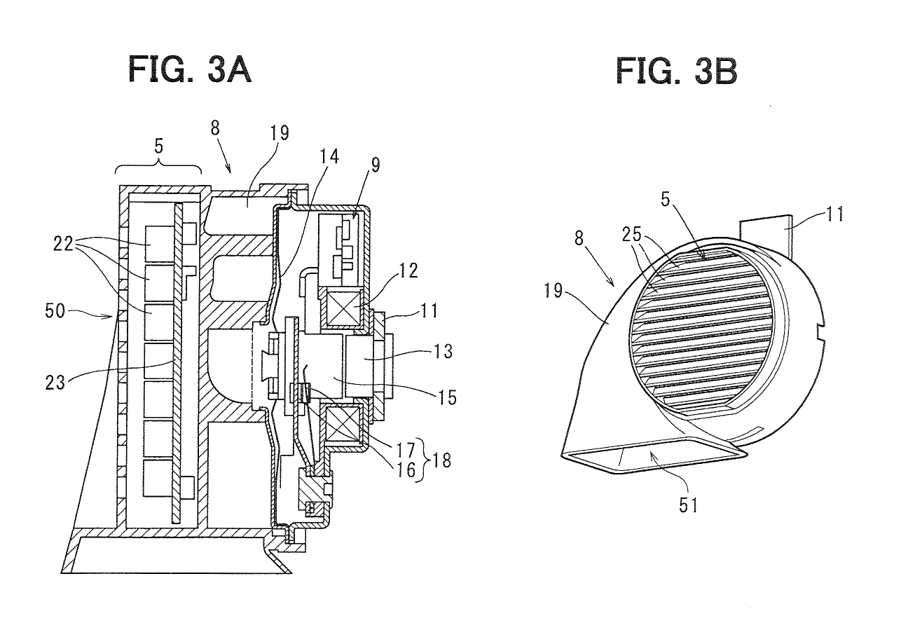

With reference now to FIGS. 3A and 3B, the vehicular horn 8 is affixed with a stay 11 at a position between the heat exchanger 1 and the front grille 3. The vehicular horn 8 includes a coil 12 to generate a magnetic force, a fixed iron core 13, a movable iron core 15, and a movable contact point 17. The fixed iron core 13 outputs an attraction force that is generated as a magnetic force from the coil 12, and may be referred to as a magnetic attraction core.

The movable iron core 15 is supported at the center of a vibration board 14 or a diaphragm. The attraction force provided by the fixed core 13, moves the movable iron core 15 towards the fixed iron core 13, and, as a result, the movable contact point 17 decouples from a fixed contact point 16, which interrupts the electric current supplied to the coil 12.

In particular, the self-excitation voltage is supplied across the coil 12 via power terminals that are coupled to the ends of the coil 12, and a current flows across the coil 12. When the self-excitation voltage is above a threshold (i.e., the voltage is equal to or greater than 8 V), an attracting action and a returning action is repeatedly performed within the vehicular horn 8.

Specifically, in regards to the attracting action, when the current flows through the coil 12, an electromagnetic field is generated and an attraction occurs between the movable iron core 15 and the fixed iron core 13, such that the movable iron core 15 moves towards the fixed iron core 13. Due to the movement of the movable iron core 15 towards the fixed iron core 13, the moveable contact point 17 decouples from the fixed contact point 16, causing the current to stop flowing through the coil 12.

Once, the current has stopped flowing through the coil 12, the electromagnetic field is no longer generated and the moveable iron core 15 returns to its initial position, which is the returning action. Due to the biasing of the movable iron core 15, the movable contact point 17 couples with the fixed contact point 16, and the current resumes flowing through the coil 12, thus restarting the attracting action.

In other words, when the self-excitation voltage is equal to or greater than the threshold voltage the current flows through the coil 12, and an electric current interrupter 18, which allows and prevents the current from flowing through the coil 12, is formed by the fixed contact point 16 and the movable contact point 17.

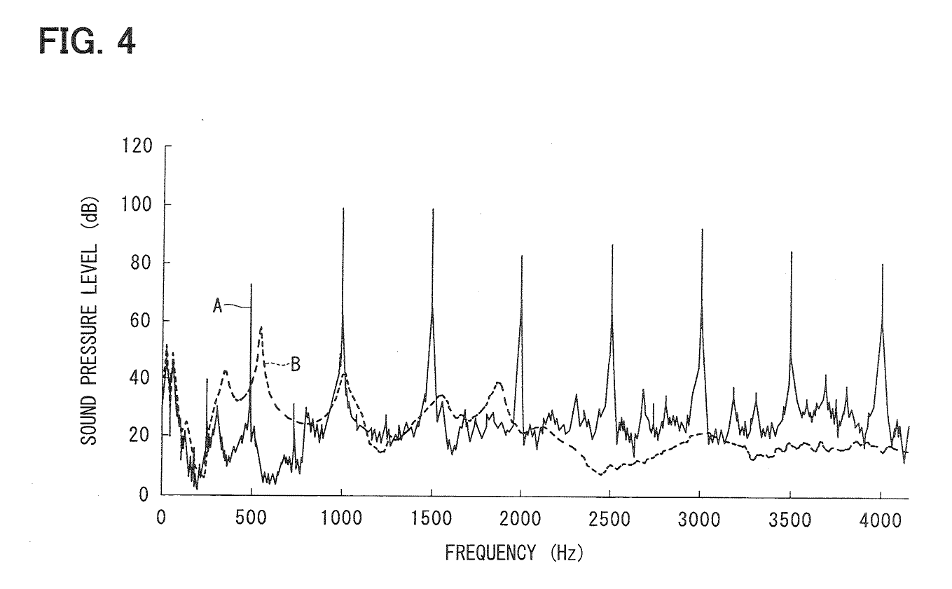

Due to the attracting and returning action, the movable iron core 15 causes a vibration of the vibration board 14, and the vehicular horn 8 generates the warning sound. The vehicular horn 8 generates the warning sound having predetermined frequencies (for example, 500 Hz and the like), one of which serves as a base sound. The frequency characteristics of the warning sound generated when the self-excitation voltage is greater than or equal to 8V by the vehicular horn 8 is shown by a solid line A in FIG. 4.

Further, in the present embodiment, the vehicular horn 8 is operated as a dynamic speaker by providing a driving signal of an excitation voltage that is lower than the threshold voltage for the vehicular horn 8, such as an excitation voltage lower than 8 V.

The frequency characteristics of the vehicular horn 8 at a time of using the vehicular horn 8 as a dynamic speaker are shown by a dashed line B in FIG. 4. The dashed line B shows the frequency characteristics when a sweep signal (i.e., a variable signal transiting from a low frequency to a high frequency) of 1 V in a sine wave form is provided for the vehicular horn 8.

Further, the vehicular horn 8 in the present embodiment is equipped with a swirl shape horn 19 (i.e., a trumpet member or a sound tube in a swirl shape) as shown in FIG. 3B, which amplifies the warning sound generated by the vibration of the vibration board 14 to output the amplified sound toward the outside of the vehicle.

The vehicular horn 8 in the present embodiment includes a swirl shape horn 19 that has a slightly curved body or curved contour that defines a horn opening 51 (i.e., a trumpet member in a swirling shape: a sound tube in a swirl shape) as shown in FIG. 3B. The swirl shape horn 19 amplifies the sound generated by the vibration of the vibration board 14, and radiates the amplified sound outward from the vehicle 100 to the surrounding area via the horn opening 51. It should be understood to one skilled in the art that the vehicular horn 8 is not necessarily limited to such configuration.

(Supersonic Speaker 5)

The supersonic speaker 5 is positioned between the heat exchanger 1 and the front grille 3, and outputs the supersonic wave toward a frontal direction of the vehicle from its installation position, which is on a side face of the swirl shape horn 19 (i.e., a side of the horn 19 that faces a front field of the vehicle 100).

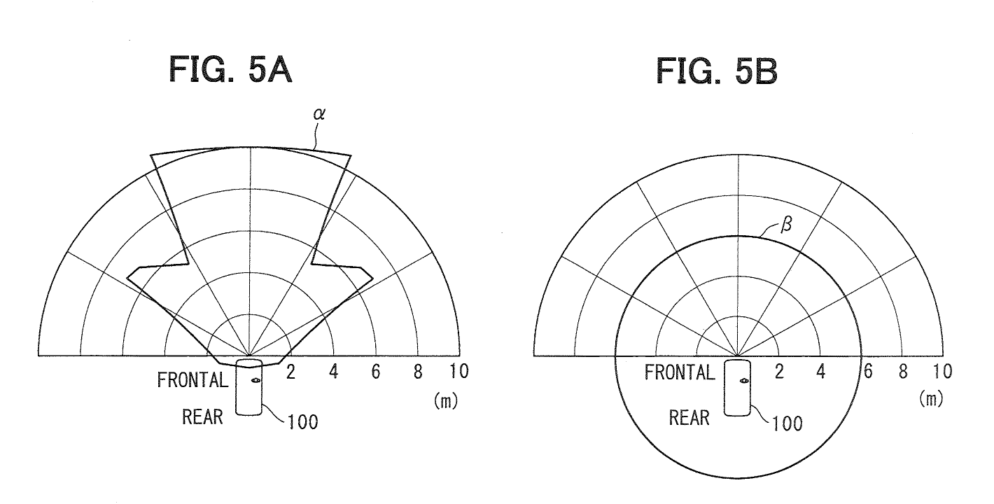

Further, the supersonic wave that is output from the supersonic speaker 5 is sent out to a front field of the vehicle 100 through a gap between grille bars 2 that constitute the front grille 3. The front field can be provided as an area in the frontal direction of the vehicle where the supersonic wave from the supersonic speaker passes through the front grille 3 to an area outside of the vehicle 100 (see FIG. 5A as an example)

The supersonic speaker 5 is a supersonic wave generator generating air vibration having a frequency that is higher than the human audible range (i.e., greater than 20 kHz).

The supersonic speaker 5 in the present embodiment includes a supersonic speaker housing 21 made of resin, which may be couple to or formed with a side face of the swirl shape horn 19, and a plurality of piezoelectric speakers 22, which may be referred to as supersonic vibrators, are accommodated in the supersonic speaker housing 21.

Each of the piezoelectric speakers 22 is disposed on a support board 23 of the supersonic speaker housing 21, to be implemented as a speaker array. Further, the piezoelectric speakers 22 have a well-known structure including the piezoelectric elements that expand and contract according to the applied voltage (i.e., the voltage from charge and discharge), and the vibration board produces air vibration by the expansion and contraction of the piezoelectric elements.

The supersonic speaker housing 21 defines a speaker opening 50 from which a supersonic wave generated by the piezoelectric speakers 22 is outputted. The speaker opening 50 includes a waterproof device that prevents an intrusion of water into the piezoelectric speakers 22.

For example, in the present embodiment the waterproof device is provided as a waterproof sheet 24 that covers the speaker opening 50 and has a supersonic wave transmitting characteristics. The waterproof device also includes a louver 25 that is positioned in front of the waterproof sheet 24 (see FIG. 1).

The louver 25 is arranged in front of the waterproof sheet 24 in order to substantial reduce the amount of water that may reach the waterproof sheet 24, and prevent water from directly hitting the waterproof sheet 24. The louver 25 is formed as multiple narrow boards that are disposed in parallel with gaps interposed therebetween.

The louver 25 can be disposed at an angle of 45 degrees against the vehicle 100's level (i.e., horizontal) direction. In such manner, the supersonic wave outputted from each of the piezoelectric speakers 22 is reflected into a downward direction on an inside of the louver 25, and is then reflected again into a horizontal direction on an outside of the louver 25 toward the front of the vehicle 100, to be output in the travel direction of the vehicle 100 (see FIG. 1).

FIG. 5A illustrates a coverage area α of the notification sound from the parametric speaker 4, which is an example of a front field, and FIG. 5B illustrates a coverage area β of the notification sound from the vehicular horn 8. The coverage areas α and β show the areas of the warning sound with its sound pressure measured as 50 dB or more. As described above, the supersonic speaker 5 of the present embodiment is disposed to emit a supersonic wave outward toward a frontal direction of the vehicle 100.

Further, the vehicular horn 8 is arranged to emit the warning sound substantially evenly around the vehicle, as shown in FIG. 4B. The horn opening 51 of the swirl shape horn 19 of the vehicular horn 8, from which the notification sound is emitted, is directed in a downward direction of the vehicle 100 to face the road surface. The direction of the horn opening 51 may also be set to another directions, and such directivity may be realized by using a reflector or the like.

(Control Circuit 9)

The vehicular horn 8 includes the control circuit 9, which includes a microcomputer chip 9a disposed on a control substrate as shown in FIG. 1, and disposed in the vehicular horn 8, as shown in FIG. 3A.

The control circuit 9 includes, as shown in FIG. 6:

(a) a notification sound generation unit 31 for generating a notification sound signal,

(b) a horn drive amplifier 32 for driving the vehicular horn 8 according to the notification sound signal,

(c) a supersonic wave modulation unit 33 for modulating the notification sound signal into a signal having the supersonic frequency,

(d) a supersonic wave drive amplifier 34 for driving the supersonic speaker 5 according to the supersonic modulated signal, and

(e) a signal process unit 35 for controlling the above-described operations.

In the following, the above-described elements of the control circuit 9 are explained.

(Notification Sound Generation Unit 31)

The notification sound generation unit 31 generates a pre-stored notification sound, such as a simulated engine sound, a single sound, a chord sound, a synthesized voice, and the like. The notification sound signal has an audible frequency according to the instruction from the signal process unit 35.

(Horn Drive Amplifier 32)

The horn drive amplifier 32 is a power amplifier that operates the vehicular horn 8 as a dynamic speaker. The horn drive amplifier 32 amplifies a notification sound signal from the notification sound generation unit 31, and outputs the amplified signal to the power terminals coupled to the coil 12 of the vehicular horn 8.

The maximum output of the horn drive amplifier 32 is restricted to 8 V or less, which is provided as the separate excitation voltage, and the voltage output from the horn drive amplifier 32 for generating the notification sound is configured to have a level that will not generate the warning sound from the vehicular horn 8. In other words, when the self-excitation voltage is equal to the separate excitation voltage (i.e. it is lower than 8V), the warning sound is not produced by the vehicular horn 8, but the notification sound is produced by the vehicular horn 8.

(Supersonic Wave Modification Unit 33)

The supersonic wave modulation unit 33 performs a supersonic modulation to a notification sound signal from the notification sound generation unit 31.

In the present embodiment, the supersonic wave modulation unit 33 uses amplitude modulation (AM modulation) for modulating the notification sound signal into a signal of amplitude change (i.e., an increase and decrease change of the voltage) in the supersonic wave frequency (e.g., 25 kHz).

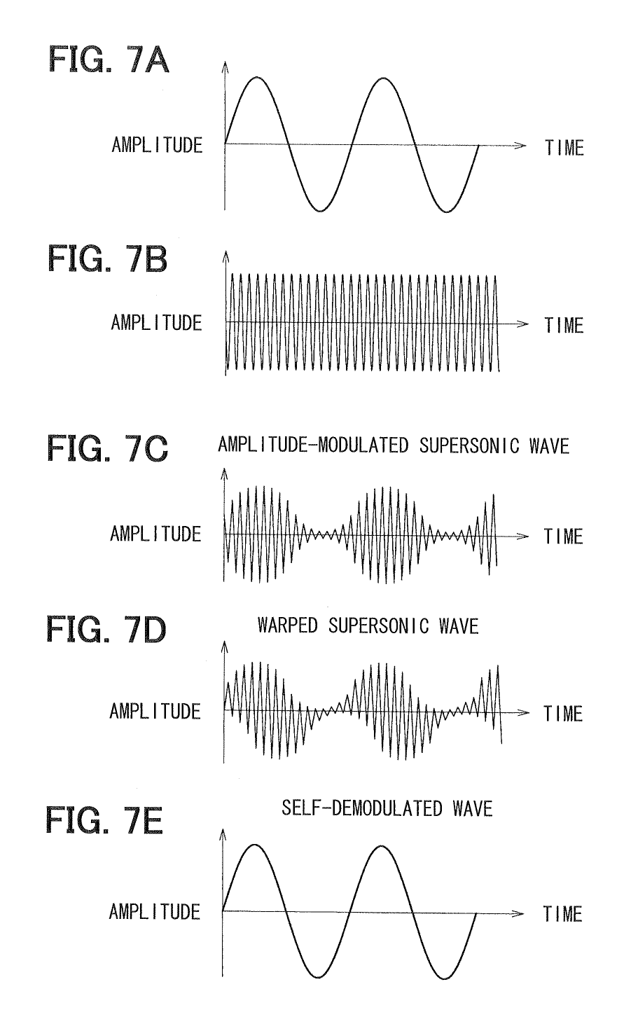

An example of the supersonic modulation by the supersonic wave modulation unit 33 is explained with reference to FIGS. 7A to 7C.

For example, a notification sound signal is provided to the supersonic wave modulation unit 33 as a voltage change having a wave form of a single frequency in FIG. 7A, which is showed for explanation purposes and should be understood that the wave form may take other forms.

A supersonic wave oscillator in the control circuit 9 oscillates at a supersonic frequency shown in FIG. 7B.

In FIG. 7C, the supersonic wave modulation unit 33 performs the following:

(i) as the signal voltage of the frequency to generate a notification sound signal increases, the supersonic wave modulation unit 33 increases the amplitude of the voltage of the supersonic wave vibration, and

(ii) as the signal voltage of the frequency to generate a notification sound signal decreases, the supersonic wave modulation unit 33 decreases the amplitude of the voltage by the supersonic wave vibration.

In the above-described manner, the supersonic wave modulation unit 33 modulates the notification sound signal output from the notification sound generation unit 31 into the amplitude change of the oscillation voltage having the supersonic wave frequency.

Further, the supersonic wave modulation unit 33 may use other modulation technique, such as pulse width modulation (PWM) that modulates a notification sound signal into a signal of width change (i.e., width of the pulse generation time) in the supersonic wave frequency.

(Supersonic Wave Drive Amplifier 34)

The supersonic wave drive amplifier 34 drives each of the piezoelectric speakers 22 based on the supersonic wave signal that is modulated by the supersonic wave modulation unit 33. That is, the supersonic wave drive amplifier 34 generates the supersonic wave, which is formed by the modulation of the notification sound signal, by controlling the applied voltage for (i.e., charging and discharging conditions of) each of the piezoelectric speakers 22.

In the present embodiment, the supersonic wave drive amplifier 34 may be a push-pull type analog amplifier (for example, a class B amplifier) that applies to each of the piezoelectric speakers 22 the increase and decrease of the voltage of the supersonic wave signal that is outputted from the supersonic wave modulation unit 33.

(Signal Process Unit 35)

The signal process unit 35 generates the notification sound when the signal process unit 35 receives a notification sound operation signal, which is an operation instruction signal, from, for example, an electronic control unit (ECU) of the vehicle 100.

The ECU may generate the notification sound operation signal in the following situations:

(i) The ECU generates the warning sound operation signal and provides the signal to the signal process unit 35 when the vehicle 100 is in a certain driving condition, which requires the output of the notification sound, such as when the vehicle 100 is traveling at a speed of 20 km/h or slower.

OR

(ii) The ECU generates the notification sound operation signal and provides the signal to the signal process unit 35 when the existence of a human being is confirmed by a human recognition system (not illustrated) in a traveling direction of the vehicle 100.

After receiving the notification sound operation signal from the ECU, the signal process unit 35 operates:

(i) the parametric speaker 4 to output a notification sound from the supersonic speaker 5, and

(ii) the vehicular horn 8 as a dynamic speaker to output the notification sound also from the vehicular horn 8.

(Operation of Vehicle Presence Notification Apparatus)

When the notification sound operation signal is provided for the signal process unit 35 from the ECU, a supersonic wave, which is inaudible, is generated by modulating the notification sound signal. The supersonic wave (FIG. 7C) is emitted from the supersonic speaker 5 under the control of the signal process unit 35 toward a frontal direction of the vehicle 100.

In FIG. 7D, as the supersonic wave travels in the air, the supersonic wave having a short wave length is warped by, for example, a viscosity of the air or the like. That is, the edge of the supersonic wave dulls, due to the attenuation of the wave energy. As a result, as shown in FIG. 7E, an amplitude component in the supersonic wave is self-demodulated during the travel of the supersonic wave, thereby reproducing the notification sound. The notification sound produced by the supersonic wave is audible at a position that is distant from the vehicle 100.

Further, when the notification sound operation signal is provided for the signal process unit 35 from the ECU, a notification sound signal is amplified and is emitted from the vehicular horn 8 under control of the signal process unit 35. As a result, the notification sound is reproduced around the vehicle 100.

(Front Grille 3)

The supersonic wave may be outputted from the supersonic speaker 5 behind the front grille 3 (i.e., passing through gaps between grille bars 2 of the grille 3), toward the front field of the vehicle.

In such structure, each of the grille bars 2 of the front grille 3 needs to have a streamline shape, for the purpose of decreasing the air resistance, which, for example, is disclosed in a Japanese Utility Model Publication No. S56-13510.

However, the amount of material used to construct the grille bars 2 may increase the thickness of the grille bars 2. The increase of the used material may cause an increase in the production cost and the weight of the product.

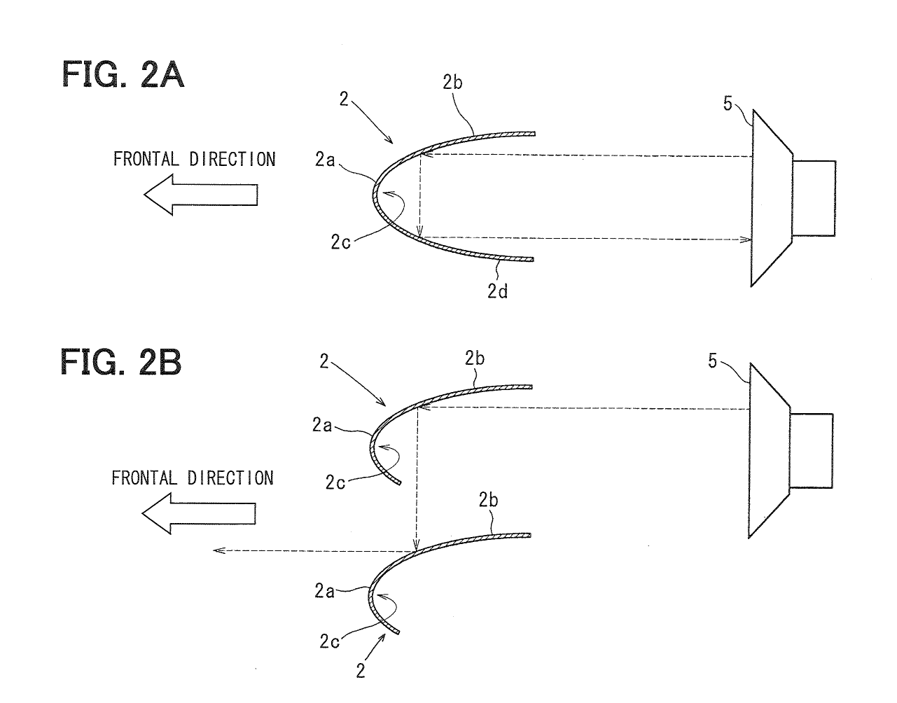

Such an increase should thus be avoided by devising a new structure of the grille bar 2 of the front grille 3. That is, as shown in FIG. 2A, the cross section of the grille bar 2 is substantially formed in a U shape that has a curved convex portion 2a, an upper plate portion 2b, a lower plate portion 2d, and with a side surface that is defined as a cavity portion 2c by at least the convex portion 2a. The cavity portion 2c decreases the thickness of the grille bar 2.

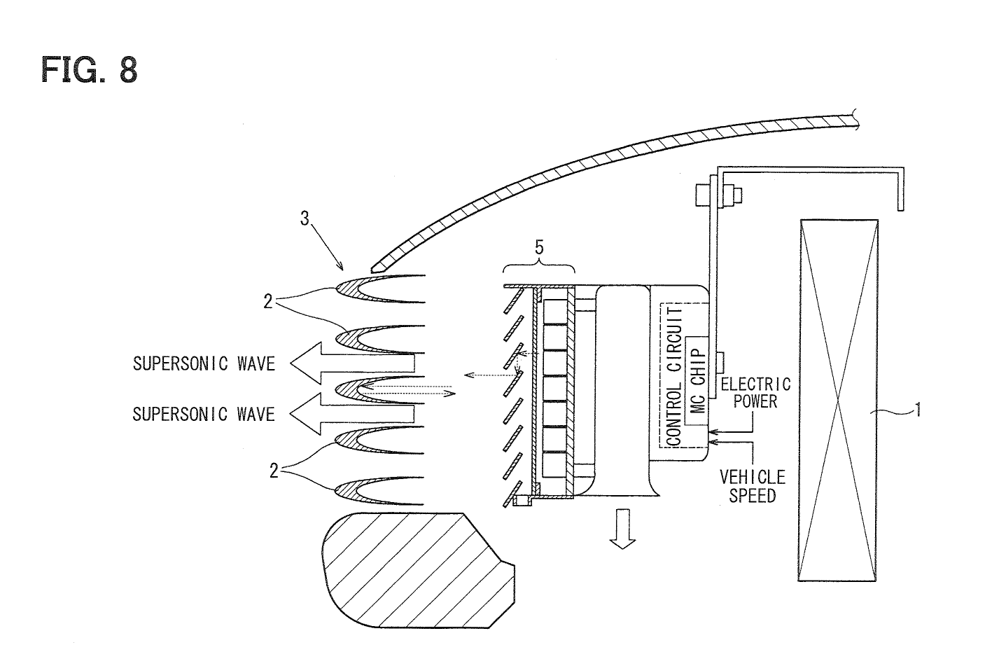

As shown in FIG. 2A and FIG. 8, when the supersonic wave is emitted from the supersonic speakers 5, a part of the supersonic wave reflects on an inside surface of the grille bar 2 of the front grille 3, which is formed substantially in U shape, and goes back to the supersonic speaker 5, as indicated by a broken line. As a result, a part of the supersonic wave is wasted by reflection, thereby deteriorating the performance of the supersonic speaker 5. Further, if such deteriorated performance of the supersonic speaker 5 due to the reflection of the supersonic wave by the grille bars 2 is supplemented by the increase of supplied electric power, the power consumption of the supersonic wave drive amplifier for driving the supersonic speaker 5 may be increased. Further, if the number of piezoelectric speakers 22 in the supersonic speaker 5 is increased to supplement the deteriorated performance of the speaker 5 due to the reflection by the grille bars 2, the volume of the speaker 5 may be increased, thereby increasing the production cost of the speaker 5, as well as deteriorating the installability of the speaker 5 in the vehicle.

To avoid such reflection, the front grille 3 in the present embodiment has the grille bars 2, which are a front range of the supersonic speaker 5, formed in a substantial U shape with the lower plate portion 2d removed therefrom (FIG. 2B). That is, the grille bars 2 that directly receive the supersonic wave in a frontal direction of the supersonic speaker 5 or the grille bars 2 overlapping with the supersonic speaker 5 in a front view of the vehicle 100, have a substantial portion of a lower element of a sideway U shape removed therefrom.

Therefore, each of the grille bars 2 in the front range of the supersonic speaker 5 only includes (a) the curved convex 2a that protrudes toward a front of the vehicle in a curved shape, (b) a cavity portion 2c defined by the curved convex portion 2a, and (c) the upper plate 2b that extends from an upper end of the curved convex 2a toward a back of the vehicle 100. In other words, a lower plate portion 2d in the original U shape is not provided. In terms of how the front grille 3 is manufactured, the grille bar 2 may have an originally-lower-plate-less shape, or the grille bar 2 may originally have a complete U shape and the lower plate 2d may be removed from the complete U shape after the molding of the complete U shape.

Further, the grille bars 2 not in the front range (i.e., in a range that does not directly receive the supersonic wave) of the supersonic speaker 5 may have the complete U shape cross section with lower plate portion 2d, or may have a U shape with the lower side plate portion 2d removed.

By devising the front grille 3 to have the above-described structure, from among the supersonic waves generated by the supersonic speaker 5, the wave reflected by the inside surface of one of the grille bars 2 changes its travel directions from a horizontal direction to a downward direction as indicated by a broken line arrow in FIG. 2B, and changes its travel direction again when reflected again by the outside surface(s) of the upper plate 2b of another or adjacent grille bar 2, thereby being output toward a frontal direction of the vehicle 100.

As a result, backward reflection of the supersonic wave by the inside surface of the grille bars 2 is prevented, thereby maintaining the performance of the supersonic speaker 5, or improving the speaker performance in substance in a vehicle installed condition.

Therefore, electric consumption by the supersonic wave drive amplifier 34 is reduced, and installability of the supersonic speaker 5 is improved by using only a small/minimum number of piezoelectric speakers 22 in the supersonic speaker 5.

Further, absence of the lower plate 2d is not visible from outside of the vehicle 100 unless the front grille 3 is being examined from the underside or lower side of the vehicle 100. That is, the structural integrity, performance, and aesthetic view of the front grille 3 is not degraded by the lack of the lower plate 2d.

In the above-mentioned embodiment, an example of the vehicular horn 8 has a swirl shape horn 19 (i.e., a trumpet member). However, the vehicular horn 8 may be implemented as a horn-less device that does not have the swirl shape horn 19 (e.g., a planar or disk shape horn that generates the warning sound based on a vibration of the vibration board 14 to hit the fixed iron core 13 and intensification of the resonance sound by the resonance of a resonance board (i.e., resonance disk)).

In the above-mentioned embodiment, a dynamic speaker (i.e., the vehicular horn 8) is used along with the parametric speaker 4 in the vehicle presence notification apparatus that embodies the present disclosure. However, the vehicle presence notification apparatus may use only the parametric speaker 4 for generating the notification sound, or may use only the dynamic speaker (i.e., the vehicular horn 8) for generating the notification sound.

Based on the foregoing, the vehicle presence notification apparatus uses a notification sound to notify a nearby pedestrian or the like of the presence and/or approach of the vehicle 100. The notification sound generated by the apparatus may be a single sound, a chord, a music piece, a voice, a simulated engine sound and the like.

The vehicle 100 may include a heat exchanger 1, a front grille 3 that has a plurality of grille bars 2 that extends horizontally to cover an opening area of the vehicle 100, and the vehicle presence notification apparatus.

The vehicle presence notification apparatus may use a parametric speaker 4 that outputs a supersonic wave outside of the vehicle based on a supersonic modulation of the notification sound. The parametric speaker 4 includes the supersonic speaker 5 that is positioned between the heat exchanger 1 and the front grille 3 for outputting a supersonic wave that radiates outward from the vehicle through a gap between the grille bars 2.

Further, at least a part of grille bars 2, which are positioned in a front area of the supersonic speaker 5 is formed in a substantial U shape with a lower side or plate 2d of the U shape cropped therefrom.

More practically, each of the grille bars 2 in the front range of the supersonic speaker 5 has (a) the curved convex 2a that protrudes toward a front of the vehicle in a curved shape, and (b) the upper plate 2b that extends from an upper end (i.e., a vertical-upside position end) of the curved convex 2a toward a back of the vehicle. In other words, the lower plate 2d that extends from a lower end (i.e., a vertical-downside position end) of the curved convex 2a toward a back of the vehicle in the original U shape is cut out therefrom.

By devising such structure, the supersonic wave from the supersonic speaker 5 will not be wasted, thereby maintaining the performance of the supersonic speaker without damaging the front grille design.

Although the present disclosure has been fully described in connection with preferred embodiment thereof with reference to the accompanying drawings, it is to be noted that various changes and modifications will become apparent to those skilled in the art, and changes, modifications, and summarized schemes are to be understood as being within the scope of the present disclosure as defined by appended claims.

What is claimed is:

1. A vehicle presence notification apparatus in a vehicle that includes a front grille to cover a front opening of the vehicle, the apparatus comprising:
a parametric speaker configured to produce a supersonic wave by supersonic modulation of a notification signal, wherein
the supersonic wave is emitted from a supersonic speaker that is arranged with the parametric speaker,
the supersonic speaker is positioned under a hood of the vehicle and behind the front grille,
the front grille includes a plurality of grille bars, the supersonic speaker emits the supersonic wave between a space defined by the grille bars,
the grille bar includes a curved convex portion that protrudes outward away from the vehicle, an upper and lower plate that extend towards the vehicle from an upper portion and a lower portion of the curved convex portion respectively, and
the grille bars that are positioned at least in front of the supersonic speaker include the curved convex portion and the upper plate portion that extends from an upper end of the curved convex toward the back of the vehicle.

2. The vehicle presence notification apparatus of claim 1, wherein the vehicle further includes a heat exchanger, and the parametric speaker is positioned between the heat exchanger and the front grille.

3. The vehicle presence notification apparatus of claim 1, wherein the front grille bar further includes a cavity that is defined by the convex portion.

4. A vehicle comprising:
a front grille configure to cover an opening defined by a vehicle body, wherein the front grille includes a plurality of grille bars that are positioned in parallel with a predetermined distance therebetween, the grille bar has a curved convex portion that protrudes outward away from the vehicle, an upper and lower plate that extend towards the vehicle from an upper portion and a lower portion of the curved convex portion, respectively; and
a vehicle presence notification apparatus that produces and emits a supersonic wave outward from the vehicle towards the front grille, wherein the vehicle presence notification apparatus includes a supersonic speaker that emits the supersonic wave from a plurality of supersonic vibrators,
wherein the grille bars that are positioned at least in front of the supersonic speaker only include the curved convex portion and the upper plate portion that extends from the upper end of the curved convex toward the back of the vehicle.

5. The vehicle of claim 4 further comprising
a heat exchanger, wherein
the parametric speaker is positioned between the heat exchanger and the front grille.

6. The vehicle of claim 4, wherein the front grille bar further includes a cavity that is defined by the convex portion.
